(19) United States
(12) Patent Application Publication
(10) Pub. No.: US 2026/0241904 A1
(43) Pub. Date: Aug. 20, 2026

(54) Method and Control Device for Automatic Brake Regulation of a Motor Vehicle

(71) Applicant: Bayerische Motoren Werke Aktiengesellschaft, Muenchen (DE)

(72) Inventors: Christian HEIDL, Garching (DE); Thomas ROSSRUCKER, Eiselfing (DE); Thomas SPICHTINGER, Muenchen (DE)

(21) Appl. No.: 18/876,737

(22) PCT Filed: Jun. 1, 2023
(86) PCT No.: PCT/EP2023/064676

§ 371 Date: Dec. 19, 2024

(30) Foreign Application Priority Data
Jun. 23, 2022 (DE) 10 2022 115 721.0

(51) Int. Cl. B60T 8/172; B60T 7/12; B60T 8/171

(52) U.S. Cl. CPC B60T 8/172; B60T 7/12; B60T 8/171; B60T 2220/04

(57) ABSTRACT

The present disclosure relates to a method and to a control device for automatic brake regulation of a motor vehicle. The disclosure also relates to a correspondingly configured motor vehicle. In the method, it is determined for a braking maneuver in each case to be carried out whether it is a standard braking maneuver within predefined safety limits or an emergency braking maneuver. If it is an emergency braking maneuver, use is made of control characteristics which are predefined and differ from standard control characteristics predefined for standard braking maneuvers, in order to control the actuation of a brake device of the motor vehicle for carrying out the braking maneuver.

### BACKGROUND AND SUMMARY

The present disclosure relates to a method and to a control device for automatic braking control of a motor vehicle. The disclosure further relates to an appropriately equipped motor vehicle.

Nowadays it is endeavored to assist or to automate—entirely or partially—the guidance of motor vehicles by assistance systems. Solutions for doing this have already been proposed, such as, for instance, automated longitudinal control of the vehicle or an emergency-braking function for the purpose of avoiding or lessening otherwise unavoidable collisions. One challenge, however, is the fact that there are differing—at least partially conflicting—set objectives. For instance, a relatively weak and jerk-free deceleration may be desirable for maximized comfort, whereas a deceleration that is as strong and fast as possible may be optimal for maximum safety which is likewise striven for.

As one proposed solution, DE 26 46 288 A1 describes a load-dependent brake-force control device for trailer braking systems. An emergency-braking valve, a relay valve and a load-dependent braking-force controller with a brake-pressure control valve are provided in this control device. The brake-pressure control valve takes the form, at the same time, of a relay valve and an emergency-braking valve. However, this constitutes a very special application which cannot readily be generalized.

DE 10 2017 209 846 B4 describes a vehicle with an emergency-braking system which is capable of being overridden adaptively. The emergency-braking system is capable of being deactivated in the event of a manual control intervention by the driver, depending on a power output of an engine of the vehicle. Similarly, a speed-limiting system of the vehicle is capable of being deactivated. In each instance an override threshold has been preset, it being possible for the override threshold for the deactivating of the emergency-braking system to be altered to the override threshold for the deactivating of the speed-limiting system if the latter threshold is greater than the override threshold for the deactivating of the emergency-braking system. An option is to be made available with which autonomous emergency braking by the emergency-braking system can be disabled by the driver by increasing the power output of the engine, even if the speed-limiting system is actively limiting the speed of the vehicle. Consequently, for the purpose of safety, an appropriate intervention option may accordingly be available to a driver.

An object of the present disclosure is to enable particularly comfortable and safe operation of a motor vehicle.

This object is achieved by virtue of the features of the present disclosure. Possible configurations and developments are disclosed in the description and in the Figures. Features, advantages and possible configurations that have been set forth within the scope of the description for one aspect of the present disclosure are to be regarded, at least analogously, as features, advantages and possible configurations of the other aspects of the present disclosure and also of any possible combination of the aspects of the present disclosure.

The method according to the disclosure can be employed for automatic braking control of a motor vehicle. In other words, the method according to the disclosure can be employed, for instance, for the purpose of controlling a braking system of the motor vehicle or an actuator for locking and releasing a brake, or braking device, of the motor vehicle. In one step of the method according to the disclosure, for a braking maneuver that is currently to be carried out, or that is impending, it is ascertained whether it is a question of a standard braking maneuver within preset safety limits, or of an emergency-braking maneuver. The safety limits preset for, or defining, a standard braking maneuver may, for instance, have been specified by one or more values of a corresponding safety parameter. Such a safety parameter may be, for instance, a spacing from an obstacle situated ahead in the direction of travel of the motor vehicle, a relative speed of the motor vehicle with respect to this obstacle, a deceleration that is necessary for avoiding a collision—that is to say, a braking acceleration—and/or such like. Similarly, a state of the motor vehicle and/or environmental conditions can be taken into account. The state of the motor vehicle may, for instance, relate to the equipment thereof or to the deceleration that is technically possible in principle or currently, possibly by reason of a type of tire, a tire pressure, a type of braking system, a switching status or conditioning status of the braking system, a temperature of the braking system, an occupancy or loading of the motor vehicle, a presence or absence of a trailer load and/or such like. The environmental conditions may, for instance, include, or relate to, a type or a condition of a local undersurface being driven along—that is to say, a constitution of the roadway—or weather conditions influencing the constitution of the roadway, and/or such like.

A standard braking maneuver may arise in a regular travel mode of the motor vehicle, in which, for instance, a collision can be avoided without exploiting the maximum deceleration, a probability of collision lies below a preset probability threshold, and/or such like. For such a standard braking maneuver, a degree of comfort for occupants of the motor vehicle, a maximizing of regeneration, a minimizing of wear or emissions, such as of brake dust or abraded tire material, and/or such like, for instance, can accordingly be prioritized.

An emergency-braking maneuver, on the other hand, may obtain, in particular, in a situation and/or in the course of a braking action outside the preset safety limits. For such an emergency-braking maneuver, the maximum possible deceleration, for instance, can be exploited or striven for. For the emergency-braking maneuver, the maximum deceleration or safety can accordingly be prioritized over passenger comfort, regeneration, wear and such like. Such an emergency-braking maneuver may, for instance, have to be carried out when it has been ascertained—possibly by an appropriate assistance system of the motor vehicle—that only by the emergency-braking maneuver can an imminent collision be avoided, and/or when a corresponding probability of collision lies above the aforementioned probability threshold, or such like.

In a further step of the method according to the disclosure, if the braking maneuver to be carried out is an emergency-braking maneuver, a control characteristic, preset only for this purpose, is used in order to control the actuation of a braking device of the motor vehicle for the purpose of executing the braking maneuver. The control characteristic that has been preset for emergency-braking maneuvers, which may also be designated here as the emergency-braking control characteristic, differs from a standard control characteristic that has been preset only for standard braking maneuvers. At least the emergency-braking control characteristic may, in particular, preset or define a specific or special dependency or characteristic curve for one or more variables of a corresponding controlled system, or corresponding control loop, or of a corresponding control device, such as a time constant, a dead time and/or other control parameters or system parameters. The standard control characteristic may correspondingly include or define at least one dependency or characteristic curve differing therefrom, or at least one fixed value, to be used only for standard braking maneuvers, of one or more system parameters or control parameters instead of a corresponding dependency preset for emergency-braking maneuvers.

For instance, depending in each instance on the type of the braking maneuver to be executed, a control characteristic corresponding thereto, such as an appropriate parameterization of a control loop, or controlled system, or of a control device for the braking maneuver, may accordingly be selected from several preset differing control characteristics and used—for instance, set or activated. The braking control can accordingly be undertaken for an emergency-braking maneuver in accordance with the emergency-braking control characteristic preset for this purpose which may also be designated as the safety characteristic or as the safety control characteristic, and for a standard braking maneuver in accordance with the standard control characteristic preset for this purpose which may also be designated as the comfort characteristic.

The use of the respective control characteristic may, for instance, imply that a corresponding control device, for instance a so-called CVM longitudinal controller (CVM: central vehicle management), is operated with this control characteristic. For an emergency-braking maneuver, the emergency-braking control characteristic or safety control characteristic is used instead of the standard control characteristic or comfort control characteristic, or a controller that has been set up in accordance with the emergency-braking control characteristic or safety control characteristic is used instead of a controller that has been set up for the standard control characteristic or comfort control characteristic, or such like.

In previous automatic braking devices, compromises have often been made, as already indicated in the introduction, between various set objectives, for instance in order to obtain sufficient safety and sufficient comfort. However, it is to be observed that a resultant braking behavior or a resultant consequent behavior of a braking controller is not always good enough actually to avoid an, in principle, avoidable collision, for instance if the braking system is new—that is to say, has not yet been broken in or bedded in and/or brought to optimal operating temperature. On the other hand, a time constant of the braking controller that has been designed to be relatively large as a compromise between safety and comfort may, for instance, result in a longitudinal oscillating of the motor vehicle, particularly for relatively low braking torques and at relatively low speeds of the motor vehicle, and this, in turn, may impair comfort or may even impair safety.

These problems can be solved, or at least very largely avoided, by the present disclosure by a distinction being made between the standard control characteristic or comfort control characteristic and the emergency-braking characteristic or safety characteristic for various braking maneuvers with correspondingly differing situation-dependent requirements. It is accordingly proposed to make the braking control, or the corresponding controlled system or control device, flexible, so that it is possible for action to be taken, or for control to be effected, differently in differing situations automatically. As a result, depending on the situation, optimal comfort without significantly impaired safety in practice, or optimal safety with then justified and desirable deprioritization of comfort in favor of safety, can be obtained.

In a possible configuration of the present disclosure, the control characteristic preset for emergency-braking maneuvers defines or determines a preset dependency of the dead time of the controlled system for the braking control on the braking torque. This braking torque may be, in particular, the braking torque currently measured or actually applied, for instance at the start of the braking maneuver and/or during the braking maneuver. As part of the method, the current braking torque can accordingly be measured, or the currently measured braking torque can be captured as input for the braking control—that is to say, for a corresponding control device. For the purpose of defining or determining this dependency, the control characteristic may, in particular, include a corresponding preset characteristic curve. By virtue of the dependency, proposed here, of the dead time of the controlled system on the braking torque, it can, for instance, be taken into account that the braking system may react differently, depending upon whether the brake pads are further away or less far away from the brake disk or are already in close contact with it. Similarly, in the course of an emergency-braking maneuver a control deviation can be detected particularly quickly, so that the braking control can also react correspondingly quickly thereto. This can enable particularly effective braking control and consequently a particularly fast and safe stopping of the motor vehicle. In contrast, for standard braking maneuvers a longer dead time of the controlled system, invariably or on average, may, for instance, have been provided or may be used, which can enable improved comfort. By virtue of the dependency proposed here, in addition a longitudinal oscillating or hunting oscillation of the motor vehicle, which is possible for previous braking controls, can be avoided or reduced. As a result, improved controllability of the motor vehicle can be obtained, where appropriate even in the course of an emergency-braking maneuver.

In a possible development of the present disclosure, the dependency provides for a shorter dead time of the controlled system for a numerically greater braking torque. The dead time of the controlled system can accordingly decline with rising numerical value of the braking torque. In other words, an inversely proportional relationship or dependency, for instance, may accordingly be obtained between the dead time of the controlled system and the numerical value of the braking torque. As a result, the hunting oscillation, or longitudinal oscillating, of the motor vehicle can be avoided or reduced particularly effectively.

In a further possible configuration of the present disclosure, the control characteristic preset for emergency-braking maneuvers defines or determines a preset dependency of a, or the, time constant of the controller of the corresponding controlled system or control device on a respective desired deceleration for the braking maneuver. The desired deceleration for the respective braking maneuver, or during the respective braking maneuver, can be captured for this purpose as part of the method as input for the braking control—that is to say, for the corresponding control device. The desired deceleration may, for instance, be output or made available by a corresponding assistance function, for instance an AEB function (autonomous emergency-braking function) of the motor vehicle. For the purpose of implementing the configuration, proposed here, of the present disclosure, the control characteristic may, in particular, include a corresponding characteristic curve. By virtue of the dependency proposed here, in the course of an emergency-braking maneuver the braking control can react particularly quickly and, at the same time, particularly safely to changes, and this may be particularly relevant for an effective, controlled and safe stopping of the motor vehicle precisely for the typically greater desired decelerations in the course of an emergency-braking maneuver in comparison with a standard braking maneuver.

In a possible development of the present disclosure, the dependency provides for a smaller time constant of the controller for a numerically greater desired deceleration. The time constant of the controller can accordingly decline with rising desired deceleration, so that the control device can then accordingly react more quickly, or may have been characterized in its control characteristic to be faster. In other words, an inversely proportional relationship or dependency, for instance, may accordingly be obtained between the time constant of the controller and the desired deceleration. A numerically greater desired deceleration implies stronger braking. Conversely, for numerically smaller desired decelerations—that is to say, a correspondingly weaker braking of the motor vehicle—a larger time constant of the controller can consequently be set or used. As a result, a longitudinal oscillating or hunting oscillation of the motor vehicle can be avoided or reduced, and for greater desired decelerations, which may be particularly relevant to safety, it is possible to react more quickly to changes, disturbing influences or control deviations. As a result, a particularly effective and particularly safe stopping of the motor vehicle can be obtained overall in the course of an emergency-braking maneuver.

In a further possible configuration of the present disclosure, the control characteristic preset for emergency-braking maneuvers defines or determines a preset dependency of the, or a, time constant of the controller on the gradient of the respective desired deceleration. This time constant of the controller may be, in particular, the time constant of the controller mentioned elsewhere. The respective desired deceleration may be, in particular, the desired deceleration mentioned elsewhere. The gradient of the desired deceleration for the respective braking maneuver, or during the respective braking maneuver, can be captured as part of the method as input for the braking control—that is to say, for the corresponding control device or controlled system—or can be calculated, for instance by reference to captured values of the desired deceleration during the braking maneuver, in particular in real time. The gradient of the desired deceleration can, for instance, be determined or ascertained by the AEB function or by the braking control—that is to say, by the corresponding control device. For the purpose of implementing the configuration, proposed here, of the present disclosure, the control characteristic may, in particular, include, define or implement a corresponding characteristic curve. By virtue of the dependency proposed here, it is possible to react automatically in appropriately adapted manner to conditions or situations changing relatively slowly, as well as to conditions or situations changing more quickly. This can enable a particularly effective and safe stopping of the motor vehicle.

In a possible development of the present disclosure, the dependency provides for a smaller time constant of the controller for a numerically larger gradient of the desired deceleration. The time constant of the controller can accordingly decline with numerically rising gradient of the desired deceleration. In other words, an inversely proportional relationship, for instance, may accordingly be obtained between the time constant of the controller and the gradient of the desired deceleration or the numerical value of the gradient of the desired deceleration. By virtue of the dependency proposed here, the braking control can react particularly quickly in the event of faster changes in the desired deceleration which may be particularly relevant for safety, whereas in the event of slower changes in the desired deceleration an unnecessarily hectic reaction, which might potentially result in an uncontrolled behavior or in a hunting oscillation, or longitudinal oscillating, of the motor vehicle, can be avoided or reduced.

In a further possible configuration of the present disclosure, a preset fixed value for the, or a, dead time of the controlled system and/or for the, or a, time constant of the controller is used for standard braking maneuvers. This dead time of the controlled system and/or this time constant of the controller may be, in particular, the dead time of the controlled system or the time constant of the controller, respectively, mentioned elsewhere. When it is ascertained that the respective braking maneuver is a standard braking maneuver, a dependency or characteristic curve for the dead time of the controlled system and/or for the time constant of the controller is not used, but rather the respective permanently preset value is used in the braking control. The braking control is then accordingly carried out using the constant dead time of the controlled system and/or the constant time constant of the controller according to the respective preset value. The respective fixed value for the dead time of the controlled system and/or for the time constant of the controller may, for instance, have been specified, contained or defined in the standard characteristic or comfort characteristic preset for standard braking maneuvers. The configuration, proposed here, of the present disclosure can enable particularly easy implementation and execution of the braking control for standard braking maneuvers. Since such standard braking maneuvers are typically less safety-critical than emergency-braking maneuvers—for instance by reason of lower desired decelerations and lower target-deceleration gradients—a comfortable and safe stopping or braking of the motor vehicle within the scope of a standard braking maneuver can, according to a finding underlying the present disclosure, also be obtained with a permanently preset value for the dead time of the controlled system and/or for the time constant of the controller.

The present disclosure also relates to a control device for a motor vehicle for controlling a braking device of the respective motor vehicle automatically. The control device according to the disclosure has been set up to execute the method according to the disclosure. The control device according to the disclosure may have been configured, for instance, as a control unit, as a control circuit, as a controller implemented in software and/or in hardware, or such like. The control device according to the disclosure may, for instance, be, or include, an electronic circuit that implements or reproduces the method steps, sequences or processes described in connection with the method according to the disclosure. Similarly, the control device according to the disclosure may include, for instance, a processor device, such as a microchip, microcontroller or microprocessor or such like, and a data memory. An operating program or computer program which is capable of being executed by the processor device for the purpose of executing or employing the corresponding method, and which codes or implements at least some of the method steps, sequences or processes described in connection with the method according to the disclosure, may then have been stored in this data memory. The control device according to the disclosure may, in particular, be, or correspond to, the control device or controlled system mentioned in connection with the method according to the disclosure.

The present disclosure also relates to a motor vehicle which exhibits a braking device, or braking system, which is capable of being actuated automatically and a control device according to the disclosure, coupled with the braking device or braking system. The motor vehicle according to the disclosure may, in particular, be, or correspond to, the motor vehicle mentioned in connection with the method according to the disclosure and/or in connection with the control device according to the disclosure. Accordingly, the motor vehicle according to the disclosure may exhibit some or all of the properties or features mentioned in these contexts, such as, for instance, the CVM longitudinal controller, the AEB function and/or such like.

Further features of the disclosure may emerge from the claims, from the Figures and from the description of the Figures. The features and combinations of features mentioned in the description, as well as the features and combinations of features mentioned below in the description of the Figures and/or shown in the Figures alone, are capable of being used not only in the respectively specified combination but also in other combinations or on their own without departing from the scope of the disclosure.

### BRIEF DESCRIPTION OF THE DRAWINGS

FIG. 1 shows a partial schematic representation of a motor vehicle that is equipped with a control device for automatic braking control using differing control characteristics; and

FIG. 2 shows an exemplary schematic flowchart for a method for corresponding braking control.

### DETAILED DESCRIPTION OF THE DRAWINGS

In previous vehicles or vehicle assistance systems, a longitudinal control of the vehicle, as well as a frontal-protection function for automatic decelerating, or stopping, of the vehicle in the event of a risk of collision, may, for instance, have already been implemented. In these systems, in the event of an imminent frontal collision an appropriate function or assistance device, for instance, can determine and output or preset a deceleration that is suitable, or that is to be applied, for the purpose of avoiding or mitigating the collision. An appropriate controller can then convert or translate this deceleration into a suitable—that is to say, corresponding—braking torque, in order to eliminate arising disturbance variables or disturbing influences as quickly as possible. However, in the course of the braking control a distinction has typically not been made hitherto between various situations or requirements, but rather a uniform control characteristic has been used. It has been shown that with this characteristic the consequent behavior of the braking control for safety-critical braking actions or emergency-braking actions is not always good enough in order actually to avoid a collision that, in principle, is avoidable, or to alleviate it with maximum effectiveness and safety. In addition, in appropriate circumstances with this characteristic the optimal comfort is not obtained in the course of standard braking actions that are not safety-critical or that are less safety-critical.

These problems may have several causes, such as the lack of an option for distinguishing between a standard characteristic or comfort characteristic, for standard braking maneuvers, and a safety characteristic, for emergency-braking maneuvers. Furthermore, a dead time of the controlled system that has been designed for comfort may hitherto have been too long for emergency-braking maneuvers or safety-critical situations, so that control deviations are, where appropriate, detected too late as regards maximum safety. Similarly, relatively high values of a time constant of a respective controller may result in a longitudinal oscillating of the vehicle, particularly for relatively low braking torques and at relatively low vehicle speeds.

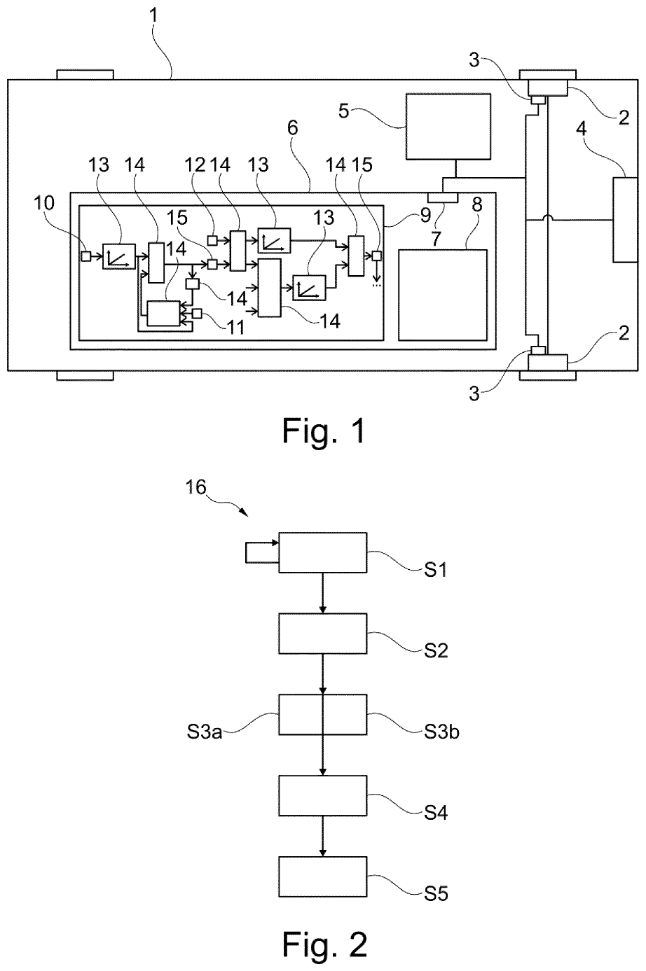

These problems can be countered by an appropriately adapted braking control. FIG. 1 shows a partial schematic representation of a motor vehicle 1 with a braking device 2. This braking device 2 may, for instance, include a brake disk and brake pads that are capable of being brought into contact with the brake disk for the purpose of braking. Similarly, the braking device 2 may include, for instance, a sensor for ascertaining or measuring a braking torque currently applied. The motor vehicle 1 also exhibits at least one brake actuator 3, for instance as part of the braking device 2 or coupled with the braking device. The at least one brake actuator 3 can be triggered or controlled automatically in order to actuate and to release the braking device 2 in appropriately controlled manner.

Furthermore, the motor vehicle 1 exhibits environmental sensorics 4 and also an assistance system 5 for assisting or automatically carrying out, at least partially, a longitudinal control of the motor vehicle 1.

In addition, the motor vehicle 1 here is equipped with a control device 6. This control device 6 has been set up for automatic braking control—that is to say, such as for controlled triggering of the brake actuator 3. For this purpose, the control device 6 here comprises, in exemplary manner, an interface 7, a processor 8 and a data memory 9. Via the interface 7, a deceleration to be set that has been determined or demanded by the assistance system 5, a current braking torque, a specification of whether a braking maneuver to be carried out is to be classified, or carried out, as a comfort standard braking maneuver or as a safety braking maneuver, or emergency-braking maneuver, and/or such like, for instance, can be captured.

At least one controlled system or control logic, which is indicated here by way of example and partially, may have been implemented in the control device 6. A respective actual braking torque 10 can be captured in the control device and used as input variable. A safety trigger 11 and the desired deceleration 12 demanded may serve as further input variables. The safety trigger 11 can specify, or be activated, if the braking maneuver to be executed is an emergency-braking maneuver—that is to say, a braking maneuver to be executed with a corresponding safety control characteristic. Furthermore, the controlled system may include several preset characteristic-curve modules 13, combination modules or calculation modules 14 and/or such like. With these modules, at least one control parameter 15, for instance, such as a dead time of the controlled system and/or a time constant of the controller, can then be determined which can then be used for the braking control. The characteristic-curve modules 13 may, for instance, specify or implement preset characteristic curves for a dependency of the time constant of the controller on the desired deceleration 12 and on the gradient of the desired deceleration 12, as well as a dependency of the dead time of the controlled system on the measured actual braking torque 10 and/or such like.

The control device 6 can implement both a comfort control characteristic or standard control characteristic, for standard braking maneuvers, and a safety control characteristic or emergency-braking control characteristic, for emergency-braking maneuvers, which may be differently parameterized, for instance as regards the time constant of the controller and the dead time of the controlled system.

For further illustration, FIG. 2 shows an exemplary schematic flowchart for a corresponding method for automatic braking control of the motor vehicle 1. In this flowchart, in a method step S1 the motor vehicle 1 can be put into operation, and, for instance, a status-monitoring system can be activated, for instance for a continuous or regular monitoring or measurement of the actual braking torque 10.

During the operation of the motor vehicle 1, a braking maneuver can then be provided by the assistance system 5, and the appropriate desired deceleration 12 can be established.

In a method step S2, this desired deceleration 12 can be captured by the control device 6.

In a method step S3a, it can be determined or captured, for instance by the assistance system 5 or the control device 6, whether the respective braking maneuver is to be executed as a standard braking maneuver—that is to say, with comfort control characteristic or standard control characteristic—or as an emergency-braking maneuver—that is to say, with safety control characteristic or emergency-braking control characteristic. In a method step S3b, the control device 6 can determine a corresponding braking torque by reference to the captured desired deceleration 12.

In a method step S4, the control device 6 can select or set the control characteristic to be used for the respective braking maneuver. In a method step S5, the control device 6 can actuate or control the braking device 2 or the brake actuator 3 to carry out the respective braking maneuver in accordance with the selected or set control characteristic until the braking maneuver has been concluded. The braking maneuver may, for instance, have been concluded if the motor vehicle 1 has been stopped—that is to say, if the speed thereof has been reduced to zero, if the assistance system 5 signals an end of the braking maneuver, or such like.

Overall, the described examples show how a CVM longitudinal control of a vehicle can be realized with a safety characteristic.

1-10. (canceled)

11. A method for automatic braking control of a motor vehicle, comprising:
ascertaining whether a braking maneuver to be carried out is a standard braking maneuver within preset safety limits or an emergency-braking maneuver; and
based on ascertaining that the braking maneuver is the emergency-braking maneuver, executing the braking maneuver by controlling an actuation of a braking device of the motor vehicle using a first control characteristic preset associated with one or more emergency-braking maneuvers that differs from a second control characteristic preset associated with one or more standard braking maneuvers.

12. The method according to claim 11, wherein the first control characteristic preset associated with the one or more emergency-braking maneuvers determines a dependency of a dead time of a controlled system on a braking torque.

13. The method according to claim 12, wherein the dependency provides for a shorter dead time of the controlled system for a numerically greater braking torque.

14. The method according to claim 11, wherein the first control characteristic preset associated with the one or more emergency-braking maneuvers determines a dependency of a time constant of a controller on a desired deceleration.

15. The method according to claim 14, wherein the dependency provides for a smaller time constant of the controller for a numerically greater desired deceleration.

16. The method according to claim 11, wherein the first control characteristic preset associated with the one or more emergency-braking maneuvers determines a dependency of a time constant of a controller on a gradient of a desired deceleration.

17. The method according to claim 16, wherein the dependency provides for a smaller time constant of the controller for a numerically larger gradient of the desired deceleration.

18. The method according to claim 11, wherein a preset fixed value for a dead time of a controlled system and/or for a time constant of a controller is used for the standard braking maneuver.

19. A control device for a motor vehicle for automatically controlling a braking device, wherein the control device is configured to:
ascertain whether a braking maneuver to be carried out is a standard braking maneuver within preset safety limits or an emergency-braking maneuver; and
based on ascertaining that the braking maneuver is the emergency-braking maneuver, execute the braking maneuver by controlling an actuation of a braking device of the motor vehicle using a first control characteristic preset associated with one or more emergency-braking maneuvers that differs from a second control characteristic preset associated with one or more standard braking maneuvers.

20. The control device according to claim 19, wherein the first control characteristic preset associated with the one or more emergency-braking maneuvers determines a dependency of a dead time of a controlled system on a braking torque.

21. The control device according to claim 20, wherein the dependency provides for a shorter dead time of the controlled system for a numerically greater braking torque.

22. The control device according to claim 19, wherein the first control characteristic preset associated with the one or more emergency-braking maneuvers determines a dependency of a time constant of a controller on a desired deceleration.

23. The control device according to claim 22, wherein the dependency provides for a smaller time constant of the controller for a numerically greater desired deceleration.

24. The control device according to claim 19, wherein the first control characteristic preset associated with the one or more emergency-braking maneuvers determines a dependency of a time constant of a controller on a gradient of a desired deceleration.

25. The control device according to claim 24, wherein the dependency provides for a smaller time constant of the controller for a numerically larger gradient of the desired deceleration.

26. The control device according to claim 19, wherein a preset fixed value for a dead time of a controlled system and/or for a time constant of a controller is used for the standard braking maneuver.

27. A motor vehicle comprising:
a braking device configured to be actuated automatically; and
a control device coupled to the braking device, the control device configured to:
ascertain whether a braking maneuver to be carried out is a standard braking maneuver within preset safety limits or an emergency-braking maneuver; and
based on ascertaining that the braking maneuver is the emergency-braking maneuver, execute the braking maneuver by controlling an actuation of the braking device of the motor vehicle using a first control characteristic preset associated with one or more emergency-braking maneuvers that differs from a second control characteristic preset associated with one or more standard braking maneuvers.

28. The control device according to claim 27, wherein the first control characteristic preset associated with the one or more emergency-braking maneuvers determines a dependency of a dead time of a controlled system on a braking torque, and wherein the dependency provides for a shorter dead time of the controlled system for a numerically greater braking torque.

29. The control device according to claim 19, wherein the first control characteristic preset associated with the one or more emergency-braking maneuvers determines a dependency of a time constant of a controller on a desired deceleration, and wherein the dependency provides for a smaller time constant of the controller for a numerically greater desired deceleration.

30. The control device according to claim 19, wherein the first control characteristic preset associated with the one or more emergency-braking maneuvers determines a dependency of a time constant of a controller on a gradient of a desired deceleration, and wherein the dependency provides for a smaller time constant of the controller for a numerically larger gradient of the desired deceleration.
